(19) United States
(12) Patent Application Publication
(10) Pub. No.: US 2020/0012744 A1
(43) Pub. Date: Jan. 9, 2020

(54) System and Method for Taxonomic Analysis of a Website

(71) Applicant: BrightEdge Technologies, Inc., Foster City, CA (US)

(72) Inventor: Ken Shults, Portland, OR (US)

(73) Assignee: BrightEdge Technologies, Inc., Foster City, CA (US)

(21) Appl. No.: 16/029,543

(22) Filed: Jul. 7, 2018

(51) Int. Cl. G06F 17/30

(52) U.S. Cl. CPC G06F 17/30902; G06F 17/30554; G06F 17/30867; G06F 17/30572

(57) ABSTRACT

In an embodiment, a set of data visualization preferences for a plurality of directories in a target domain is received, along with a keyword landscape for a target domain. The keyword landscape is parsed according to the target domain's website structure, providing a structured landscape. Search volume data for a plurality of keywords in the keyword landscape is also received, the search volume data including a plurality of search volume data points calculated periodically for a predetermined number of time periods. A search trend is then calculated for at least a subset of the website structure in the target domain over the predetermined number of time periods, and a data aggregation is then calculated, the data aggregation based on the structured, landscape, the received search volume data, the calculated search trend, and the received set of data visualization preferences. Finally, the calculated aggregated data is displayed in graphical form.

### BACKGROUND

The disclosed embodiments relate generally to a taxonomic analysis of a website. In particular, the disclosed embodiments relate to systems and methods for editing the program code underlying a website based on an analysis of the website's data and metadata for components in the website's structure.

Modern internet search engines are highly dependent on how the various web pages within websites are organized and arranged, and in particular, how websites are structured. The configuration of a website contributes to a determination of how web pages are ranked when returned as search results. The ultimate goal of most website designers is to design and structure the website in a way that optimizes driving traffic to the web page. This is generally true for all websites, but it is particularly true for eCommerce websites. Thus, it is advantageous to structure a website in a way that ensures a relatively high ranking on a search page.

Search engine optimization can be described as the process of affecting the online visibility of a website or a web page in a web search engine's unpaid results—often referred to as natural, organic, or earned, results. In general, the earlier (or higher ranked on the search results page), and more frequently a website appears in the search results list, the more visitors it will receive from the search engine's users. For many websites, that kind of visibility is correlated with the ability of a website to attract new potential customers and ultimately earn money, whether from advertisements or online sales.

This is particularly true for eCommerce websites, which typically include significantly more pages than a personal website or a website that simply displays business information. For some eCommerce websites, the number of pages that make up the site can be in the millions because often those websites contain pages for categories of products and individual product-listing pages.

To allow users to find relevant content, websites are imbedded with keywords within their structure, and the interplay among the keywords and the structure can determine the usefulness of a keyword search. That interplay, however, can be exceedingly complex, relying on the combination of keywords used for the search, the structure of the target website, the periodic search volume, the number of words contained in a search, the category searched, and others. In addition, eCommerce-based websites tend to see changes in both searches and search results over time, along with a strong seasonality component to search and results trends. These changes make it very difficult for eCommerce sites to provide consistent service as they move up and down the search-results page for a given search. Without an understanding of the interaction among the various factors, both improving SEO and presenting relevant search results in a consistent way may be nearly impossible.

Ultimately, one would like to know which factors contribute most to improving SEO, and so a need exists for a method of analyzing search results to provide a market-based analysis of a website's structure, thereby providing an ability to design or alter a website in a way that provides both structure and content to drive traffic and maximize revenue.

### SUMMARY

In an embodiment, a set of data visualization preferences for a plurality of directories in a target domain is received. In addition, a keyword landscape for a target domain is received, the keyword landscape including a plurality of keywords for at least one directory in the target domain. Once the keyword landscape is received, it is parsed according to a website structure of the target domain to provide a structured landscape. Search volume data for at least a plurality of keywords in the keyword landscape is also received, the search volume data including a plurality of search volume data points calculated periodically for a predetermined number of time periods. A search trend is then calculated for at least a subset of the website structure in the target domain over the predetermined number of time periods, and a data aggregation is then calculated, the data aggregation based on the structured, landscape, the received search volume data, the calculated search trend, and the received set of data visualization preferences. Finally, the calculated aggregated data is displayed in graphical form.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for creating a website taxonomy, according to an embodiment of the invention.

FIG. 2 is a flow chart of a process for creating a visualization of a website taxonomy, according to an embodiment of the invention.

FIG. 3 is a flow chart of a process for data collection, parsing, and sampling, according to an embodiment of the invention.

FIG. 4 is a flow chart of a process for determining demand data, growth trends, and seasonality trends, according to an embodiment of the invention.

FIG. 5 is a flow chart of a process for data categorization, aggregation, and visualization, according to an embodiment of the invention.

### DETAILED DESCRIPTION

One or more of the systems and methods described herein describe a way of analyzing the data and metadata underlying website usage, based on the structural elements of the website, typically for the purpose of editing the website's program code in a way that drives appropriate traffic to the website. As used in this specification, the singular forms “a” “an” and “the” include plural referents unless the context clearly dictates otherwise. Thus, for example, the term “a computer server” or “server” is intended to mean a single computer server or a combination of computer servers. Likewise, “a processor,” or any other computer-related component recited, is intended to mean one or more of that component, or a combination thereof. One skilled in the art will understand that a web page is a document on the Internet, and that a website comprises one or more web pages that are linked together.

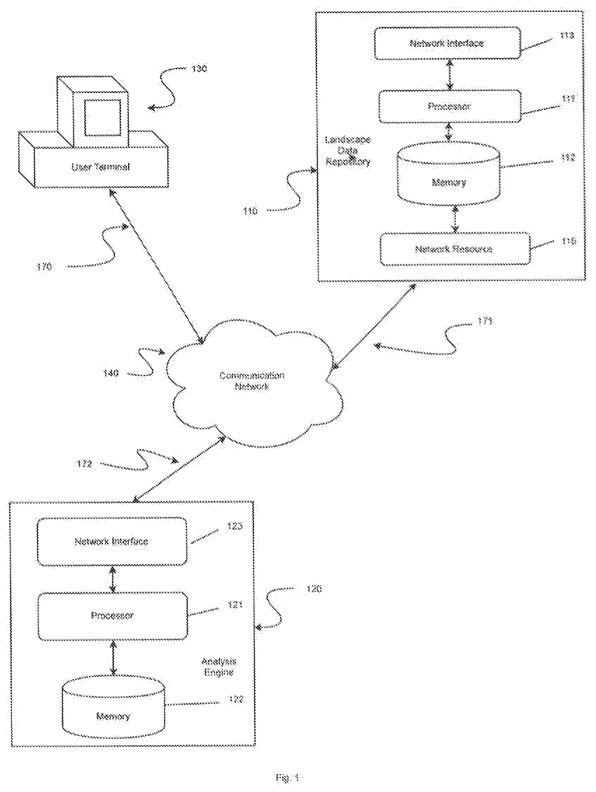

FIG. 1 is a block diagram of a system for creating a data and metadata taxonomy of a website, according to an embodiment of the invention. This embodiment comprises user terminal 130, analysis engine 120, and landscape data repository 110. In an embodiment, analysis engine 120, user terminal 130, and landscape data repository 110 are operatively coupled to one another through communication network 140 via network connection 170, which connects user terminal 130 to communication network 140 network connection 171, which connects landscape data repository 110 with communication network 140, and network connection 172, which connects analysis engine 120 with communication network 140.

Network connections 170, 171, and 172 can be any appropriate network connection, physical, wireless, or otherwise, for operatively coupling user terminal 130, analysis engine 110, and landscape data repository 120 to communication network 140.

Communication network 140 can be any communications network configurable to allow analysis system 120 to communicate with or to other network elements through communication network 140. Communication network 140 can be any network or combination of networks capable of transmitting information (e.g., data and/or signals) and can include, for example, a telephone network, an Ethernet network, a fiber-optic network, a wireless network, and/or a cellular network. In some embodiments, communication network 140 can include multiple networks operatively coupled to one to another by, for example, network bridges, routers, switches and/or gateways. For example, user terminal 130 can be operatively coupled to a cellular network, analysis engine 120 can be operatively coupled to an Ethernet network, and landscape data repository 110 can be operatively coupled to a fiber-optic network. The cellular network, Ethernet network and fiber optic network can each be operatively coupled one to another via one or more network bridges, routers, switches and/or gateways such that the cellular network, the Ethernet network and the fiber-optic network are operatively coupled to form a communication network. Alternatively, for example, the cellular network, the Ethernet network, and the fiber-optic net work can each be operatively coupled to the Internet such that the cellular network, the Ethernet network, the fiber-optic network and the Internet are operatively coupled to form a communication network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection. In some embodiments, a user terminal, partner application and/or landscape data repository can be operatively coupled to a communication network by heterogeneous network connections. For example, a user terminal can be operatively coupled to the communication network by a WWAN network connection, a partner application can be operatively coupled to the communication network by a DSL network connection, and a landscape data repository can be operatively coupled to the communication network by a fiber optic network connection. In some embodiments, the data flowing across the network connections and communications network flow through a physical connection from one element to another.

In an embodiment, analysis engine 120 comprises a network interface 123, a processor 121, and a memory 122. Analysis engine is operatively coupled to user terminal 130 and landscape data repository 110 through communication network 140 via network connection 172. User terminal 130 is connected to analysis system 120 through communication network 140 via network connection 170, and landscape data repository 110 is operatively coupled to user terminal 130.

In an embodiment, network interface 121 can be any network interface configurable to be operatively coupled to communication network 140 via network connection 172. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

In an embodiment, both the landscape data repository 110 and analysis engine 120 can be based on any combination of hardware and software. In an embodiment, landscape data repository 110 includes network interface 113, processor 111, memory 112, and network resource 115. Landscape data repository 110 is operatively coupled to communication network 140 via network interface 113 and network connection 171. Network interface 113 can be any network interface configurable to be operatively coupled to communication network 140 via network connection 171. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

Processor 111 is operatively coupled to network interface 113 such that processor 111 can be configured to be in communication with communication network 140 via network interface 113. In an embodiment, processor 111 (and processor 121) can be any of a variety and combination of processors, and can be distributed among various types and pieces of hardware, or even across a network. Such processors can be implemented, for example, as hardware modules such as embedded microprocessors, microprocessors as part of a computer system, Application Specific Integrated Circuits (“ASICs”), and Programmable Logic Devices (“PLDs). Some such processors can have multiple instruction executing units or cores. Such processors can also be implemented as one or more software modules in programming languages as Java, C++, C, assembly, a hardware description language, or any other Suitable programming language. A processor according to some embodiments includes media and program code (which also can be referred to as code) specially designed and constructed for the specific purpose or purposes.

Processor 111 is also operatively coupled to memory 112 which, in an embodiment, can be used to store keyword landscapes, web pages, searches, search results, and any other data necessary for analysis engine 120 to perform at least a part of the invention. In an embodiment, memory 112 (and memory 122) can be a read-only memory (“ROM”); a random-access memory (RAM) such as, for example, a magnetic disk drive, and/or solid-state RAM such as static RAM (“SRAM) or dynamic RAM (“DRAM), and/or FLASH memory or a solid-data disk (“SSD), or a magnetic, or any known type of memory. In some embodiments, a memory can be a combination of memories. For example, a memory can include a DRAM cache coupled to a magnetic disk drive and an SSD.

In addition to memories 112 and 122, some embodiments include another processor-readable medium (not shown in FIG. 1) having instructions or program code thereon for performing various processor-implemented operations. Examples of processor-readable media include, but are not limited to: magnetic storage media Such as hard disks, floppy disks, and magnetic tape; optical storage media Such as Compact Disc/Digital Video Discs (“CD/DVDs), Compact Disc-Read Only Memories (“CD-ROMs), and holographic devices: magneto-optical storage media such as floptical disks; Solid state memory such as SSDs and FLASH memory; and ROM and RAM devices. Examples of program code include, but are not limited to, micro-code or micro-instructions, machine instructions (such as produced by a compiler), and files containing higher-level instructions that are executed by a computer using an interpreter. For example, an embodiment may be implemented using HTML, Java, C++, or other object-oriented programming language and development tools. Additional examples of program code include, but are not limited to, control signals, encrypted code, and compressed code.

In some embodiments, landscape data repository 110 can be a virtual device implemented in Software such as, for example, a virtual machine executing on or in a processor. For example, a landscape data repository can be a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

Likewise, Processor 121 is operatively coupled to network interface 123 such that processor 121 can be configured to be in communication with communication network 140 via network interface 123. Processor 121 is also operatively coupled to memory 122 which, in an embodiment, can be used to store keyword landscapes, program code, analytics, web pages, searches, search results, and any other data necessary for analysis engine 120 to perform at least a part of the invention.

In some embodiments, an analysis engine can be a virtual device implemented in software such as, for example, a virtual machine executing on or in a processor. For example, an analysis engine can be a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

As illustrated in FIG. 1, landscape data repository 110 includes network resource 115. Network resource 115 can be, for example, a web server and/or database accessible over communication network 140. Network resource 115 is configured to, for example, send a web page or other data formatted in hypertext markup language (“HTML”) or other languages to user terminal 130, which user terminal 130 can display to a user.

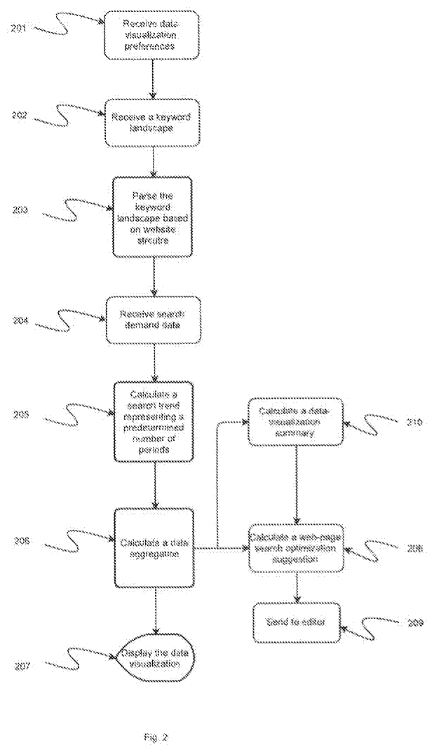

In some embodiments, a network resource can include a database configured to process database queries received by a landscape data repository over a communication network. In some embodiments, a network resource can exchange encoded binary data, such as images, videos, and/or documents, for example, with a user terminal over a communication network. In some embodiments, a network resource can include a database configured to process database queries received by landscape data repository 110 over communication network 140. In some embodiments, a network resource can exchange encoded binary data, such as images, videos, and/or documents, for example, with a user terminal over a communication network. FIG. 2 is a flow chart of a process for creating a visualization of a website taxonomy, according to an embodiment. In one embodiment, the process in FIG. 2 is implemented by at least a subset of components in a taxonomy system. Data visualization preferences are received, at 201. The data visualization preferences can be described as rules to organize and display data in a preferred way that allows, ultimately, for automating the process for aligning processed data to the structure of the target website. The set of data visualization preferences includes processor-readable preferences about how a user would prefer to visualize the data. In an embodiment, data visualization preferences are received from an end user. In another embodiment, data visualization preferences are received from a landscape data repository. In another embodiment, data visualization preferences are calculated by an analysis engine and supplied to a processor. In an embodiment, the set of data visualization preferences includes some combination of search trend (how often a particular search-term is entered relative to the total search-volume across various regions of the world), search average (the average number of times a search keyword or collection of search keywords is entered in search engines by searchers), share of voice (how much of the conversation with target consumers your brand owns versus your competitors), opportunity (how much total search volume exists for a particular search keyword or collection of search keywords), performance (an estimate of the total volume of search referrals received by a website based on the websites current ranking position and the estimated click through rates by ranking position multiplied by the search volume for each keyword). In an embodiment, the data visualization preferences include at least one of a preselected time period and a preselected target geometry. In an embodiment, the data visualization preferences are based on the received search demand trend data.

At 202, a keyword landscape for a target domain is received. In an embodiment, the target domain is a website that includes at least one directory. For the purposes of the present invention, a keyword landscape means a collection of keywords that represents the majority of search traffic received by the website, and includes a plurality of keywords for at least the one directory in the target domain. In an embodiment, the keyword landscape includes, for each keyword (or for at least one of the keywords) represented by the landscape, data signifying some combination of a blended rank (the sequential position of the listing URL (the URL of the page that appears in the Search Engine Results in the ranking position represented by the Blended Rank) on the search engine results page), a monthly search volume (the average number of times the search keyword is entered in the search engine by searchers on a monthly basis), a subrank (the sequential position in the subordinate search engine results when such are provided by the search engine), a results page number (the page number of the search results on which the listing appears), a number of words (a count of the actual number of discrete words that appear in the keyword phrase) and a category (the specific type of listing including for example images, quick answers, video, or regular web listing). In an embodiment, the keyword landscape includes a tag that signifies whether a keyword is the name of a brand or not, also called a brand-nonbrand keyword tag.

In an embodiment, the keyword landscape is received from a landscape data repository. For example, the keyword landscape can be received from some combination of BrightEdge Datacube™, Google search console, and other databases that provide a combination of keywords and URLs associated in some way with each keyword, and that include data and/or metadata analytics that pertain to those keywords.

At 203, the keyword landscape is then parsed based on the website structure such that the data that pertains to each keyword is organized according to the different elements of the target website's structure, thus providing a structured landscape of the target domain. In one embodiment, the structure can be based on the directory structure of the target website. In another embodiment, the structure can be based on the website's breadcrumbs, or on any other way a user can understand and navigate a website hierarchy.

Once the keyword landscape is parsed according to the website structure and a structured landscape is created, search volume data is received, at 204. For the purposes of the present invention, the term search volume data means the average number of times a search keyword is entered in search engines by searchers on a monthly basis. The search volume data includes a plurality of search volume data points. In one embodiment, the search volume data points are calculated periodically for a preselected number of time periods. In an embodiment, the search volume data points are calculated periodically for a target geometry. At 205, a search demand trend, or search trend, is calculated for at least a subset of directories in the target domain. In an embodiment, the calculated search demand trend is in the form of a slope value, wherein the calculated slope values are calculated for at least one of growth type and growth pace. In an embodiment, the search demand trend is calculated for the preselected number of time periods. In an embodiment, the search demand trend is calculated for the preselected target geometry.

In an embodiment, the slope values for each keyword are further categorized by growth types including strong growth where the slope value is strongly positive, flat where the slope vale is close to zero and strong decline where the slope value is strongly negative.

In an embodiment, growth pace is calculated by comparing the calculated slope values of the full 48 months of search volume data with the most recent 24 months of search volume data. If the slope of the 48 months is positive and if the slope for the most recent 24 months is greater than the full 48 months, then the growth pace is determined to be rising faster. If the slope of the 48 months is positive and the slope of the most recent 24 months is less than the full 48 months. then the growth pace is determined to be shifting negative.

Based on the structured landscape, the received search volume data, the calculated search trend, and the received set of data visualization preferences, a data aggregation is calculated, at 206. In an embodiment, the calculated data aggregation is based on the calculated slope value. In an embodiment, the data aggregation calculation is the sum of the search volume for all keywords according to the structure of the website.

Finally, at 207, the calculated search trend is displayed to a user, either numerically or graphically, or both.

In an embodiment, at 208, a web-page search optimization suggestion is calculated, based on the calculated data aggregation. In an embodiment, the web-page search optimization suggestion includes program code configured to modify a web page in a way intended to improve SEO for that web page. In an embodiment, the web-page search optimization suggestion includes a combination of text and images to be inserted in the web page.

One skilled in the art will understand, in the context of embodiments of the invention, that the term “a combination of” includes zero, one, or more, of each item in the list of items to be combined.

In an embodiment, a data visualization summary is calculated, the data visualization summary including a human- or machine-readable description of the data visualization. In an embodiment, the data visualization summary includes an interpretation of the data and a suggestion to a user involving how to use the data in their business.

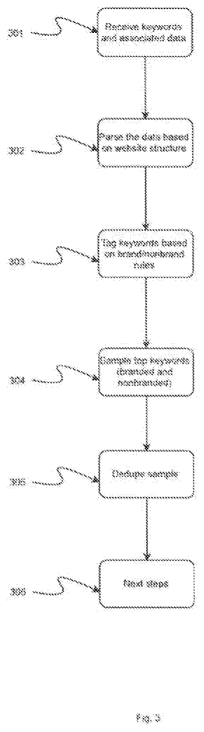

FIG. 3 is a flow chart of a process for data collection, parsing, and sampling, according to an embodiment of the invention. In an embodiment, data is selected to be a representative sample from a large universe of data, and then reduced to a minimum (or smaller) amount of data necessary to produce the maximum (or greater) amount of insight. In an embodiment, the data is parsed based on structure to improve sampling from all the corners of the website, thus create a data sample with maximum relevance to the website.

Keywords are collected, at 301, along with associated URLs and other relevant data, from any of a variety of known sources. For example, the keywords can be collected from BrightEdge Data Cube®, from Google search console, or from any other database or combination of databases that provide a combination of keywords and URLs associated in some way with each keyword. In addition, data can be collected from any combination of these sources that include data about keywords, URLs, blended ranks, monthly search volume, subrank, search-results-page number, the number of words in a search term, and the category.

Once the data is collected, at 304, it is parsed in a way that is based on the website structure, that is, the directory structure of the target website. In an embodiment, the website structure can be based on the website's breadcrumbs, or on any other way a user can understand and navigate a website hierarchy.

In an embodiment, the collected keywords can be categorized according to whether they refer to a brand name or not, and such categorized keywords can be tagged as brand keywords or nonbrand keywords, at 303, for use in other parts of the process, or in other processes.

In an embodiment, a top tier of keywords is identified and sampled, at 304. For the purposes of the present invention, top tier can mean most popular, most searched, most returned, or most responsible for driving current performance for the website. In an embodiment, the top tier of keywords tagged as branded are sampled. In an embodiment, the top tier of keywords tagged as nonbranded are sampled. In either embodiment or both embodiments, the sampling can be based on a variety of metrics, including a monthly search volume, a BrightEdge Data Cube score, or any other available keyword metric.

The sample is deduped, removing duplicate keyword entries, at 305. Once the sample is deduped, allowing for overlap of individual keywords appearing under multiple areas of the landscape based on the parsing structure, now the dataset is categorized in a way that allows for an analysis of demand, growth trends, and seasonality changes.

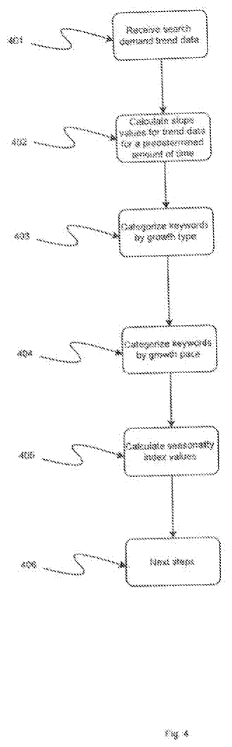

FIG. 4 is to find out everything we need to know about that data that has nothing to do with the website.

FIG. 4 is a flow chart of a process for determining demand data, growth trends, and seasonality trends, according to an embodiment of the invention. At 401, search demand trend data is received. In an embodiment, the set of deduped keywords determined in 305 are used as the input for 401. In an embodiment, the data can be any historical data that can be used to show a trend in the data over a preselected period of time. For example, the search demand trend data can be data collected from the previous 48-month period to show a change (or not) in the use of a certain keyword search, or access to a web page, or a search result, or any other data that can be used to analysis how a website is searched or accessed, or otherwise used. In an embodiment, the search demand trend data is received from any combination of Google Adwords Keyword Planner, and any other appropriate data source.

Once the search demand trend data is received, a slope value for the trend data is calculated over a predetermined period of time, at 402. The slope value is used to represent a change in the data over the predetermined period of time. For example (but not the only example), if the trend data has a positive slope over the most recent 48 months, or the most recent 24 months, the trend can be said to be increasing for that period of time; if the trend has a negative slope over time, the trend can be said to be decreasing for that period of time; if the trend has a zero slope over time, the trend can be said to be remaining constant for that period of time.

Once the slope values for trend data are calculated for a predetermined amount of time, keywords are then categorized by growth type over one or more predetermined periods of time, at 403. In an embodiment, growth is defined as a determination of the growth and/or decline in the use of the keyword by searchers in search engines.

In an embodiment, growth type categorization is done by assigning growth descriptors to numerical slope values. In an embodiment, the numerical slope value used can be the raw number calculated as the slope. In another embodiment, the numerical slope value used can be the raw number calculated as the slope, multiplied by an arbitrary number that improves visualization or understanding of the slope value. In another embodiment, the numerical slope value can be the value of a mathematical function, such as a logarithm, applied to the raw number calculated as the slope.

As an example, but not the only example, keywords can be categorized by growth type for the most recent 48 months and the most recent 24 months. If the slope times 100 (slope*100) is less than −1.5, the growth type can be considered to be in strong decline. If slope*100 is between −1.5 and −0.4, the growth type can be considered to be in moderate decline. If slope*100 is between −0.4 and 0.4, the growth type can be considered to be flat. If slope*100 is between 0.4 and 1.5, the growth type can be considered to be experiencing moderate growth. And if slope*100 is greater than 1.5, the growth type can be considered to be experiencing strong growth.

At 404, the calculated slope values for trend data are used to categorize keywords by growth pace (a determination of the nature of the Growth in the use of a particular keyword). This can be done in any mathematical way by determining the change in slope over a predetermined period of time or times. In an embodiment, growth pace can be determined by comparing the keyword slope for a 48-month period to the keyword slope to a 24-month period that occurs during the 48-month period. By way of example (but not the only example), the keyword usage slope is calculated for the monthly search volume data over a 48-month period, giving a 48-month slope value. In addition, the keyword usage slope is calculated over a 24-month period, giving a 24-month slope value. Finally, we can subtract the 24-month slope value from the 48-month slope value, give a slope-value difference. If the 48-month slope value is, for example, less than zero, and the slope-value difference is also less than zero. The growth pace can be said to be falling quickly. If the 48-month slope value is greater than zero and the slope-value difference is less than zero, the growth pace can be said to be shifting negative. If the 48-month slope value is less than zero and the slope-value difference is greater than zero, the growth pace can be said to be shifting positive. If the 48-month slope value is greater than zero and the slope-value difference is also greater than zero, the growth pace can be said to be rising quickly.

Seasonality index values for each keyword are calculated, at 405. In an embodiment, seasonality index values are calculated for at least one of individual keywords and for collections of keywords organized according to the structure of the site into hierarchical categories. In an embodiment, the seasonality index for each keyword can be calculated by dividing the monthly search volume (the average number of times that a keyword is entered in a search engine by searchers on a monthly basis) by an n-month index value. For example, if a user decides to calculate a seasonality index value for all the months in a year, then the n-month index value be a 12-month index value.

In an embodiment, each keyword includes 48 months of search volume data. The 48 months are divided into four 12-month blocks. Within each 12-month block an intermediate indexed monthly search volume is calculated for each month. For a given month the calculation is equal to the monthly search volume for the month divided by the average search volume for the 12-month block. The final 12-month index value for each month is the average of the four monthly intermediate 12-month index values. The 12-month index value allows us to understand the seasonal variances in search interest from month to month.

One skilled in the art will understand that the calculation can create index values for any specified period of time. In one embodiment, the seasonality index values are determined using an average monthly search volume for each keyword over four distinct 12-month groups, however, for the purposes of the invention, search volume does not need to be limited to a 12-month period. Any time period can be used if a user (or automated algorithm) determines that that particular time period is appropriate. Likewise, determining an average monthly search volume can be performed an arbitrary number of times for an arbitrary period of time, as long as the number of times and the period of time are clearly defined.

At 406, each of the categorizations for keyword growth type at 403, keyword growth pace in 404, and seasonality index value at 405 can be used for any next steps that are deemed appropriate. For example, they each can be visualized, graphed, reported to a client, or a recommendation can be made based on the output of the categorization or calculation, respectively.

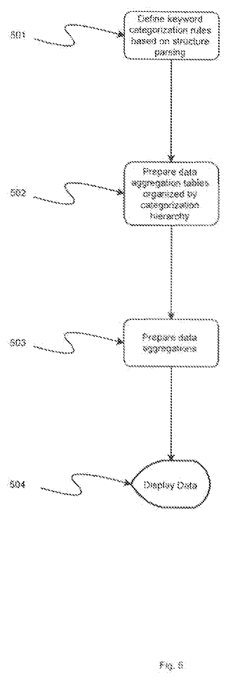

FIG. 5 is a flow chart of a process for data categorization, aggregation, and visualization, according to an embodiment of the invention. In an embodiment, the steps performed in FIG. 4 are website agnostic. The flow in FIG. 5 generally organizes and aggregates the keyword data in alignment with the structure of the target website, thereby providing a view into appropriate website structure and content to improve access to and opportunity for various pages in that website.

In an embodiment, keyword categorization rules are defined, at 501. These rules are based on the data that was parsed in FIG. 3 at 302. In an embodiment, keywords associated with URLs under a Level 1 Directory are tagged as level 1 keywords, while keywords that are associated with URLs under a Level 2 Directory are tagged as level 2 keywords. For example, in an embodiment, a Level 1 Directory can be defined as Level 1 Directory=/Directory X/; a Level 2 Directory can be defined as Level 2 Directory=/Directory X/Directory Y/. On skilled in the art will understand that, generally, one can tag keywords associated with a Level N Directory as level N keywords, where the Level N Directory=/Directory 1/Directory 2/ . . . /Directory N/.

At 502, data aggregation tables are prepared, organized by categorization hierarchy. In an embodiment, for each directory level in a website keywords are aggregated, trends are aggregated, and seasonality is aggregated. Data aggregations for each level in the categorization hierarchy are then calculated, at 503. The calculated data aggregations are then displayed, at 504. In an embodiment, the data is displayed in numerical form. In an embodiment, the data is displayed in graphical form.

For the purposes of the present invention, the term computer program includes software, firmware, middleware, and any code in any computer language in any configuration, including any set of instructions or data intended for, and ultimately understandable by, a computing device.

One skilled in the art will understand that the order of elements described in each figure is given by way of example only. In an embodiment, the order of elements performed can be changed in any practicable way.

In some embodiments, the processes in FIGS. 2-5, or any portion or combination thereof, can be implemented as software modules. In other embodiments, the processes in FIGS. 2-5, or any portion or combination thereof, can be implemented as hardware modules. In yet other embodiments, FIGS. 2-5, or any portion or combination thereof, can be implemented as a combination of hardware modules, software modules, firmware modules, or any form of program code.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiments are illustrated in the figures and described above, the present disclosure should in no way be limited to the exemplary implementations and techniques illustrated in the drawings and described herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

We claim:

1. A method, comprising:
receiving, at a processor, a set of data visualization preferences for a plurality of directories in a target domain;
receiving, at the processor, a keyword landscape for a target domain, the keyword landscape including a plurality of keywords for at least one directory in the target domain;
parsing the received keyword landscape based on a website structure of the target domain to provide a structured landscape of the target domain;
receiving search volume data for at least a subset of the plurality of keywords in the keyword landscape, the search volume data including a plurality of search volume data points calculated periodically for a predetermined number of time periods;
calculating a search trend for at least a subset of the website structure in the target domain over the predetermined number of time periods;
calculating, based on the structured landscape, the received search volume data, the calculated search trend, and the received set of data visualization preferences, a data aggregation; and
displaying the calculated data aggregation as a data visualization in graphical form.

2. The method of claim 1, wherein the keyword landscape further includes, for each keyword in the plurality of keywords, data signifying at least at least one of: a blended rank, a monthly search volume, a subrank, a results page number, and number of words.

3. The method of claim 1, wherein the website structure includes at least one of a directory structure and breadcrumb data.

4. The method of claim 1, further comprising:
calculating, based on the data aggregation, a web-page search optimization suggestion to optimize at least one of: domain structure and domain content; and
sending the web-page search optimization suggestion to a web-page editor.

5. The method of claim 1, wherein the data visualization preferences include at least one of: search trend, search average, share of voice, opportunity, and performance.

6. The method of claim 1, wherein the received keyword landscape further includes at least one brand-nonbrand keyword tag.

7. The method of claim 1, further comprising:
removing duplicate keywords from the parsed keyword landscape.

8. The method of claim 1, wherein the data visualization preferences include at least one of a preselected period of time and a preselected target geography, and further comprising:
receiving search volume data for at least one of the predetermined time periods and the preselected target geometry; and
calculating a search demand trend, based on the received search volume data, for at least one of the preselected time periods and the preselected target geometry;
wherein the calculated data aggregation is further based on the received search demand trend data.

9. The method of claim 8, further comprising:
calculating slope values for the received search demand trend data, wherein the calculated slope values are calculated for at least one of growth type and growth pace, and wherein the calculated data aggregation is further based on the calculated slope values for the received search demand trend data.

10. The method of claim 8, further comprising:
calculating, for each keyword in a plurality of keywords in the received keyword landscape, a seasonality index value, wherein the calculated data aggregation is further based on the calculated seasonality index value.

11. The method of claim 9, further comprising:
sending, to an end user, a data visualization summary, the data visualization summary being based at least in part on the calculated data aggregation.

12. A processor readable medium storing program code, the program code configured to, when executed:
receive a set of data visualization preferences for a plurality of directories in a target domain;
receive a keyword landscape for a target domain, the keyword landscape including a plurality of keywords for at least one directory in the target domain;
parse the received keyword landscape based on a website structure of the target domain to provide a structured landscape of the target domain;
receive search volume data for at least a subset of the plurality of keywords in the keyword landscape, the search volume data including a plurality of search volume data points calculated periodically for a predetermined number of time periods;
calculate a search trend for at least a subset of the website structure in the target domain over the predetermined number of time periods;
calculate, based on the structured landscape, the received search volume data, the calculated search trend, and the received set of data visualization preferences, a data aggregation; and
display the data aggregation as a data visualization in graphical form.

13. The processor readable medium of claim 12, wherein the keyword landscape further includes, for each keyword in the plurality of keywords, data signifying at least at least one of: a blended rank, a monthly search volume, a subrank, a results page number, and number of words.

14. The processor readable medium of claim 12, wherein the web site structure includes at least one of a directory structure and breadcrumb data.

15. The processor readable medium of claim 12, wherein the data visualization preferences include at least one of: search trend, search average, share of voice, opportunity, and performance.

16. The processor readable medium of claim 12, wherein the received keyword landscape further includes at least one brand-nonbrand keyword tag.

17. The processor readable medium of claim 12, wherein the data visualization preferences include at least one of a preselected period of time and a preselected target geography, the program code further configured to, when executed:
receive search volume data for at least one of the predetermined time periods and the preselected target geometry; and
calculate a search demand trend, based on the received search volume data, for at least one of the preselected time periods and the preselected target geometry;
wherein the calculated data aggregation is further based on the received search demand trend data.

18. The processor readable medium of claim 17, the program code further configured to, when executed:
calculate slope values for the received search demand trend data, wherein the calculated slope values are calculated for at least one of growth type and growth pace, and wherein the calculated data aggregation is further based on the calculated slope values for the received search demand trend data.

19. The processor readable medium of claim 17, the program code further configured to, when executed:
calculate, for each keyword in a plurality of keywords in the received keyword landscape, a seasonality index value, wherein the calculated data aggregation is further based on the calculated seasonality index value.

20. The processor readable medium of claim 17, the program code further configured to, when executed:
send, to an end user, a data visualization summary, the data visualization summary being based at least in part on the calculated data aggregation.
